(19) United States
(12) Patent Application Publication
(10) Pub. No.: US 2012/0292003 A1
(43) Pub. Date: Nov. 22, 2012

(54) DEVICE FORMING A CHEMICAL REACTOR WITH IMPROVED EFFICIENCY, INCORPORATING A HEAT EXCHANGING CIRCUIT

(75) Inventors: Raphael Couturier, Sassenage (FR); Charlotte Bernard, Contamine Sur Arve (FR); Jean-Marc Leibold, Pont de Claix (FR); Patrice Tochon, Uriage Les Bains (FR); Fabien Vidotto, Fontaine (FR)

(73) Assignee: Commissariat a l'energie atomique et aux energies alternatives, Paris (FR)

(21) Appl. No.: 13/521,342

(22) PCT Filed: Jan. 10, 2011
(86) PCT No.: PCT/EP11/50215

§ 371 Date: Jul. 10, 2012

(30) Foreign Application Priority Data
Jan. 11, 2010 (FR) 10 50132

(51) Int. Cl. F28F 1/10; B23P 15/26

(52) U.S. Cl. 165/172; 29/890.054

(57) ABSTRACT

A device forming a chemical reactor including a first circuit configured to form a chemical reactor, wherein the first circuit includes plural channels, wherein flow at least two chemicals intended to react with one another, wherein the channels have a three-dimensional structure including bends and junctions forcing the fluid to change direction, and a second heat exchange circuit including multiple channels, wherein a heat transfer fluid flows, positioned as close as possible to the channels wherein the reaction occurs.

### TECHNICAL FIELD AND PRIOR ART

The present invention relates to a device comprising at least one first circuit intended to cause an active fluid to flow, for example to allow a chemical reaction between at least two chemical reagents contained in said fluid, and at least one second circuit transferring heat to the first circuit, or extracting heat from the first circuit, and to a method of production of such a device.

The document “Topologic mixing on a microfluidic chip”, H. Chen and J-C Meiners, in Applied Physics Letters, Vol. 84, Number 12, pages 2193-2195, March 2004 describes a particularly effective blending circuit, in which the liquid flow is divided into two flows and then brought together again, in periodic fashion. When the flow is divided into two it is forced to change direction. These particular trajectories imposed on the particles of fluids provokes chaotic laminar flow movements. These geometries thus enable a certain degree of blending to be accomplished rapidly. In addition, there is no short circuit, and very few dead zones in the bends of the circuit.

Another blending circuit architecture is also described in the document “Novel interconnection technologies for integrated microfluidic systems”, N. L. Gray and al., in “Sensors and Actuators” 77 (1999) 57-65.

These structures are very effective in producing blends, and are used in particular in the field of life sciences to produce blends.

It could be envisaged to use these structures as chemical reactors since they accomplish a close blending of the chemical reagents, and therefore improved yield. However, for such a use, the heat must be able to be extracted from the circuit efficiently, in order not to slow the reactions, and to prevent thermal runaway. It can also be advantageous to be able to contribute heat as close to the circuit as possible in order to initiate and/or accelerate the reaction. Current devices do not comprise efficient means to accomplish such heat exchanges.

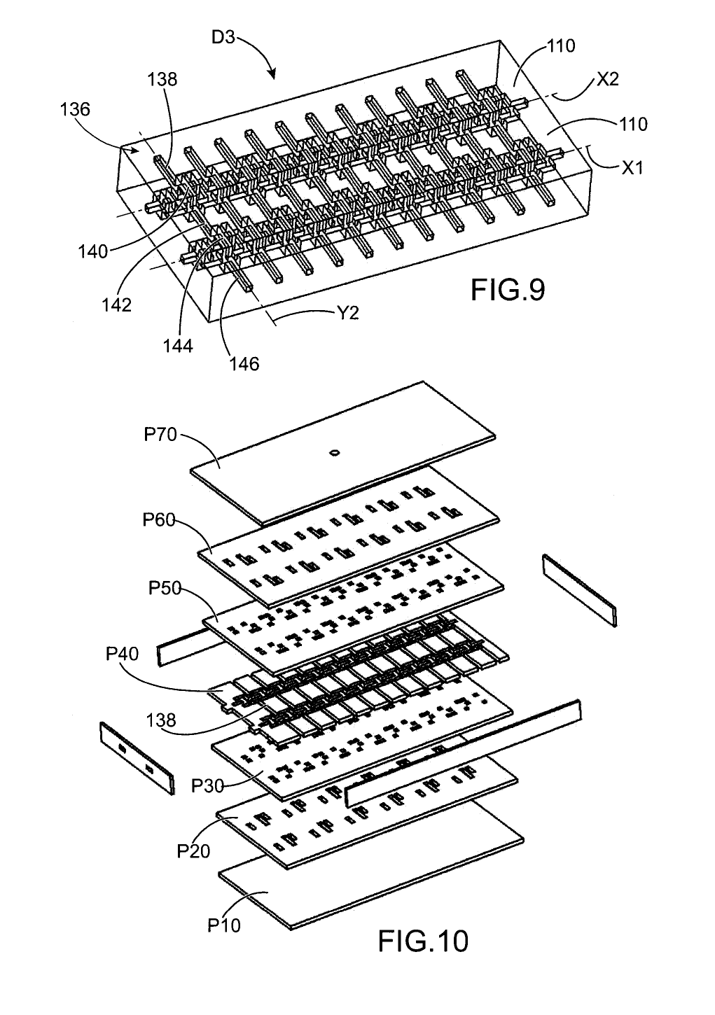

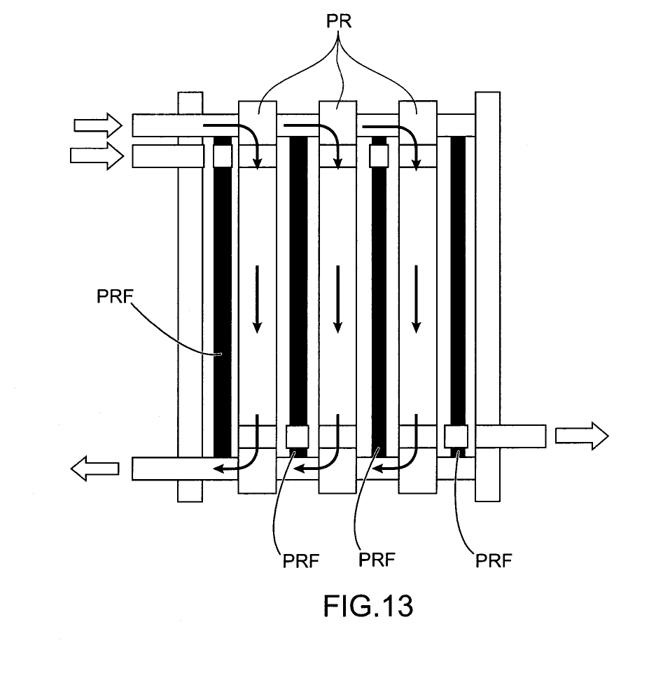

The methods used hitherto require substantial thicknesses, which means that a heat transfer fluid cannot flow in proximity to the flow in the blending circuit. In addition, the only possibility in current devices to add or extract heat is to cause a heat transfer fluid to flow around the device, and more specifically around the flows, as represented in FIG. 13, which represents a device with PR plates, in which a reaction occurs, alternating with PRF cooling plates, in which a heat transfer fluid flows. Cooling is not therefore optimal. The document “Heat exchanger/reactors (HEX reactors): Concepts, technologies: State-of-the-art” in “Chemical Engineering and Processing Process Intensification” 47 (2008) 2029-2050 describes, in FIG. 9, a reactor comprising a central channel in which the reaction occurs, and two lateral channels in which the cooling liquid flows.

In addition, these structures are difficult to manufacture industrially. For example, manufacture by founding, i.e. by casting and core making, cannot apply to parts which are too complex, as is the case here. Injection casting is not economically suiprotrusionle for large parts. Manufacturing of the fast prototyping type, with a step of fritting and laser fusion of powder, does not enable parts having isotropic mechanical characteristics to be obtained, and the parts obtained are of limited size.

### ACCOUNT OF THE INVENTION

It is consequently one aim of the present invention to provide a device capable of allowing a close blending between at least two chemical reagents, such, for example, that they react with one another, whilst accomplishing an efficient heat exchange with the exterior.

Another aim of the present invention is to provide a method for simple production of such a structure which can be used on an industrial scale.

The device according to the present invention comprises a first circuit intended to form a chemical reactor, called the “blending circuit”, in which flow at least two chemical substances intended to react with one another, where the first said circuit forms at least one three-dimensional structure comprising bends and junctions, forcing the fluid to change direction, and a second circuit called the “heat exchange circuit” positioned as close as possible to the blending circuit.

In other words, at least one heat exchange structure is embedded with a blending structure, where the blending structure causes a succession of separation and folding phases in the fluid flow.

In an example embodiment the blending circuit comprises at least one channel defining a flow in a first direction, where the heat exchange circuit then defines a flow in a transverse direction.

In another example embodiment the blending circuit and the heat exchange circuit define flows which are roughly aligned in the same direction, and where the two circuits are embedded with one another.

Advantageously, each circuit comprises several channels, the directions of which are roughly parallel.

The production method involves the use of a diffusion welding step, preferentially by hot isostatic pressing. To accomplish this, the device is produced in the form of superimposed plates, where the plates comprise slots defining portions of one or both circuits.

According to a first example embodiment, the device for blending at least two fluids comprises a circuit for blending said fluids and a heat exchange circuit in which a heat transfer fluid is intended to flow,
where said blending circuit comprises multiple channel networks positioned side-by-side, where the channels of each network are interconnected, defining an average flow direction between a first longitudinal end and a second longitudinal end, where the average flow directions of the multiple networks of channels are parallel, where each network comprises common flow portions which are roughly parallel to the average flow direction, separation portions dividing the flow into two, where the separation portions are connected to a common upstream flow portion and a common downstream flow portion, and where each separation portion forces at least three changes of flow direction,
where said heat exchange circuit comprises multiple separate channels positioned side-by-side, where said channels are positioned within the blending circuit, and extend from a first transverse end to a second transverse end, such that the average transverse flow direction in the exchange circuit is roughly perpendicular to the average flow direction in the blending circuit, and where each of said channels is positioned between two successive separation portions of the networks of channels of the blending circuit,
where the average longitudinal flow direction and the average transverse flow direction define an average flow plane,
where at least one change of flow direction occurs in a plane other than the average flow plane,
where said at least one network of interconnected channels of the blending circuit is delimited by a first and a second end plane, both parallel to the average flow plane,
where said heat exchange circuit is positioned between said first and second end planes.

The changes of direction are, for example, at right angles to one another. Advantageously, roughly identical load losses occur in the separation portions.

For example, the heat exchange circuit network comprises common parts and separation portions connected to common upstream and downstream portions, where the separation portions extend either side of the common parts of the blending circuit network. The heat exchange circuit may comprise two separate parallel channels located either side of the average flow plane.

1. According to a second example embodiment, the device for blending at least two fluids comprises a circuit for blending said fluids and a heat exchange circuit,
where said blending circuit comprises multiple channel networks positioned side-by-side, where the channels (310) of each network are interconnected, where each network defines an average flow direction between a first longitudinal end and a second longitudinal end, where said network comprises common flow portions which are roughly parallel to the average flow direction, where separation portions divide the flow into two, where the separation portions are connected to a common upstream flow portion and a common downstream flow portion, where each separation portion forces at least three changes of flow direction, and where the average flow directions of the multiple networks are parallel,
where said heat exchange circuit comprises multiple separate channels, where said channels are positioned within the blending circuit and extend from a first longitudinal end to a second longitudinal end, such that the average flow in the exchange circuit is roughly parallel to the average flow in the blending circuit, where each of said channels is positioned inside a space delimited by the channels forming the separation portions of a network of channels.
where the average longitudinal flow direction and a transverse flow direction define an average flow plane,
where at least one change of flow direction occurs in a plane separate from the average flow plane,
where said at least one network of interconnected channels of the blending circuit is delimited by a first pair of end planes which are parallel to one another, and parallel to the average flow plane, and a second pair of end planes which are parallel to one another, and where the straight line intersecting with at least one of the planes of the first and at least one plane of the second pair of planes is parallel to the average flow direction,
where said at least one channel of the heat exchange circuit is positioned between said first and second pairs of end planes.

The direction of flow of a heat transfer fluid in the heat exchange circuit (C2) is preferably opposite the direction of flow in the blending circuit (C1) over at least a part of the heat exchange circuit.

The networks of the blending circuit are, for example, connected such that the fluids to be blended flow at least in a first flow direction and in a second flow direction.

In a particularly advantageous manner, the device comprises multiple superimposed metal plates, where each comprises a portion of the blending circuit and/or of the heat exchange circuit, where said plates are connected by diffusion welding. In an even more advantageous manner the plates are connected by hot isostatic pressing.

In an example embodiment the heat exchange circuit is formed by interposing metal pipes between the plates.

In another example embodiment, the heat exchange circuit is formed by pairs of grooves made in faces of the superimposed plates facing one another.

According to the first embodiment, the device may comprise side walls and longitudinal end walls surrounding the stack of plates, where the longitudinal end plates comprise piercings to connect the blending circuit to a system supplying the fluid for blending, and to connect the heat exchange circuit to a system which causes a heat exchange fluid to flow.

According to the second embodiment, the device may comprise side walls and longitudinal end walls surrounding the stack of plates, where the longitudinal end plates comprise piercings to connect the blending circuit to a system supplying the fluid for blending, and the side walls comprise piercings to connect the heat exchange circuit to a system which causes a heat exchange fluid to flow.

At least one of the plates of the stack advantageously comprises, in at least one longitudinal end face, a longitudinal protrusion for each network of the blending circuit, where said protrusion is aligned with the average axis of said associated network, and in which the longitudinal end plate covering this face comprises slots to receive each longitudinal protrusion.

The device is preferably made of stainless steel. The metal pipes defining the heat exchange circuit are also advantageously made of stainless steel.

Another subject-matter of the present invention is a method for the production of a blending device according to the present invention, comprising the following steps:

a) cutting of multiple metal plates of roughly parallelepipedic shape,

b) cutting of patterns in at least a part of the plates,

c) stacking of the plates such that the patterns define the blending and heat exchange circuits,

d) connection of said plates by diffusion welding,

e) cutting of the longitudinal faces to reveal the ends of the networks of the blending circuit, and to enable them to be connected to a supply system.

In step c) metal pipes can be interposed between the plates to form the heat exchange circuit.

The stack of plates produced in step c) may comprise lower and upper metal plates containing no cut-outs, where said method may comprise a step c′) of installation of side plates and of longitudinal end plates, so as to form a sealed container with the upper and lower plates with no cut-outs, and step c″) of degassing of the interior of said container.

### BRIEF DESCRIPTION OF THE ILLUSTRATIONS

The present invention will be better understood by means of the description which follows and the appended illustrations, in which:

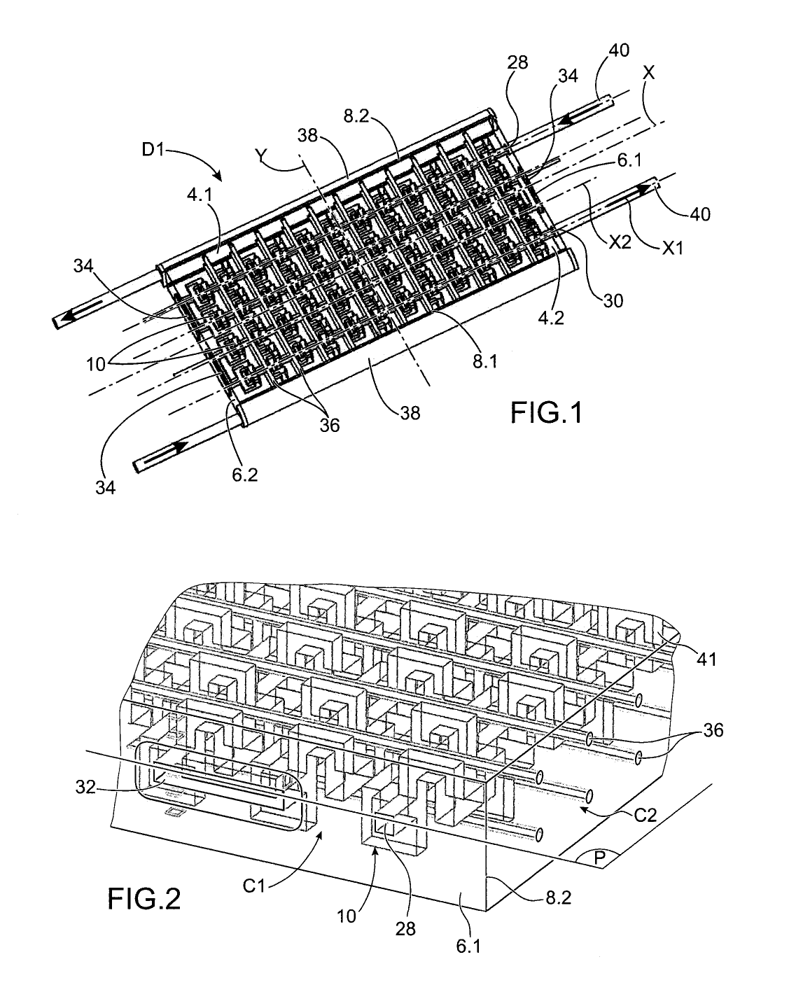

FIG. 1 is a perspective view in transparency of a first example embodiment of a blending device,

FIG. 2 is an enlarged partial perspective view in transparency of the device of FIG. 1 seen at flow ends of the blending circuit,

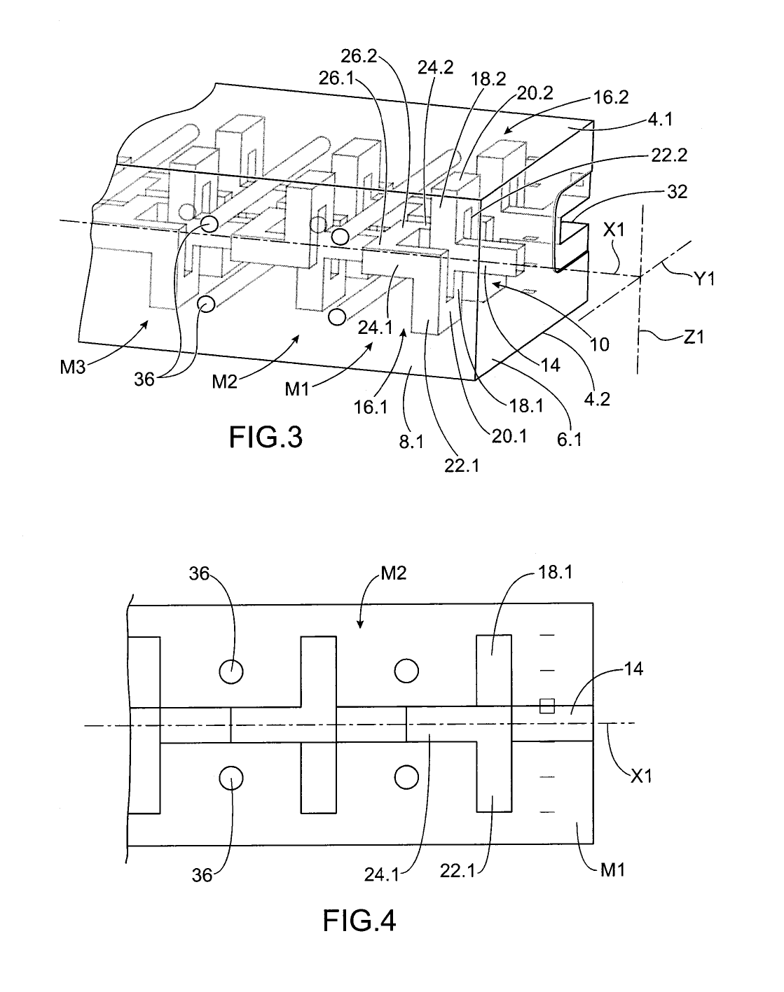

FIG. 3 is an enlarged perspective view in transparency of the device of FIG. 1 seen at flow ends of the heat exchange circuit,

FIG. 4 is a dimensional drawing of the device of FIG. 1 seen at flow ends of the heat exchange circuit,

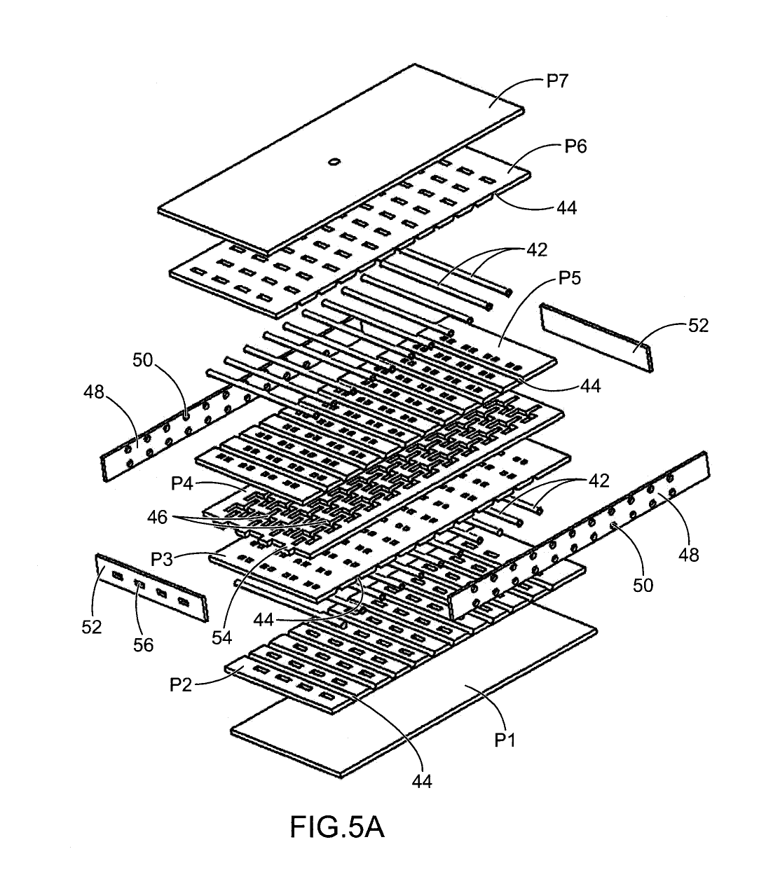

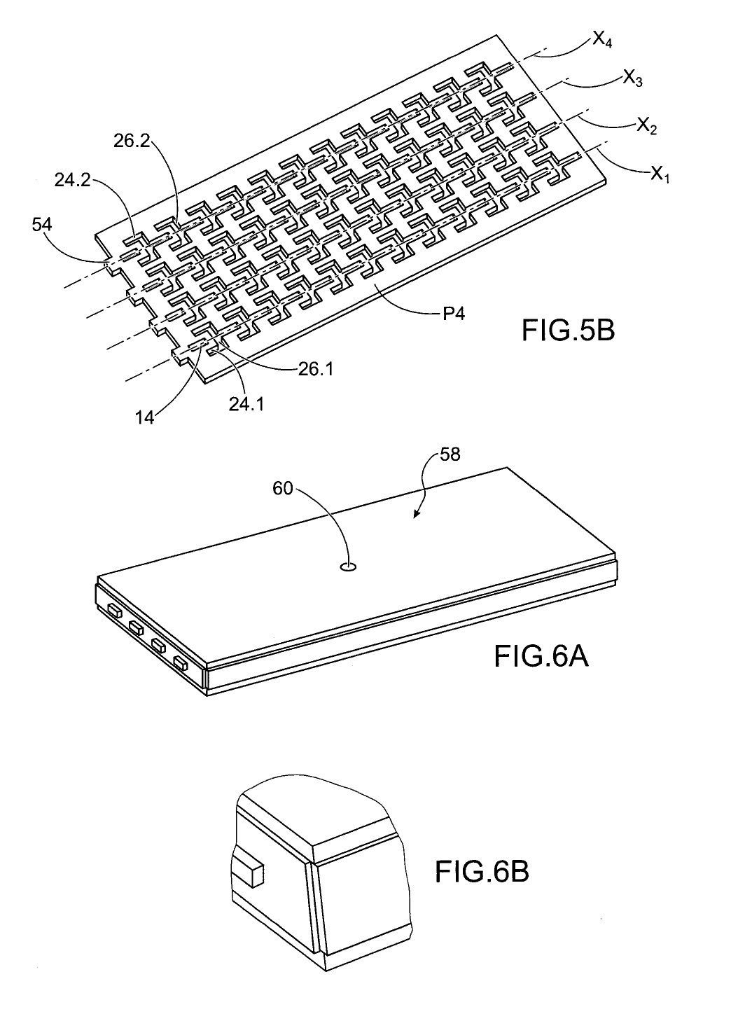

FIG. 5A is an exploded view of the device of FIG. 1 before its assembly by hot isostatic pressing,

FIG. 5B is a detailed view of a plate of the device of FIG. 5A,

FIG. 6A is a perspective view of the device of FIG. 5A when assembled,

FIG. 6B is a detailed view of FIG. 6A,

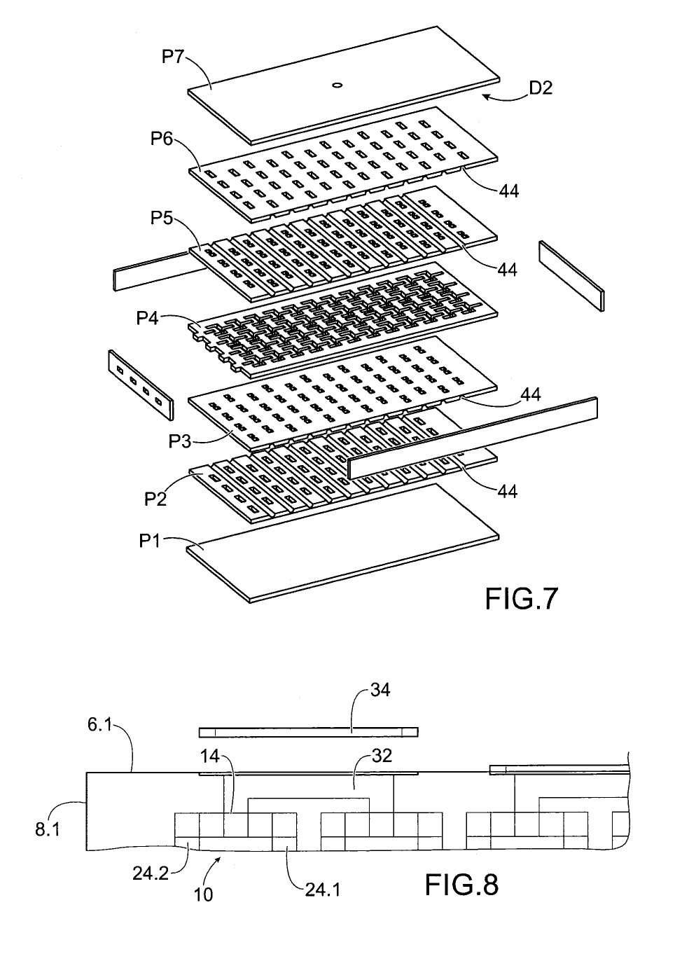

FIG. 7 is an exploded view of a second example embodiment of a device before its assembly by hot isostatic pressing,

FIG. 8 is a detailed view of an end of the device according to the first embodiment at ends of the blending circuit,

FIG. 9 is a perspective view in transparency of a third example embodiment of a device,

FIG. 10 is an exploded view of the device of FIG. 9 before its assembly by hot isostatic pressing,

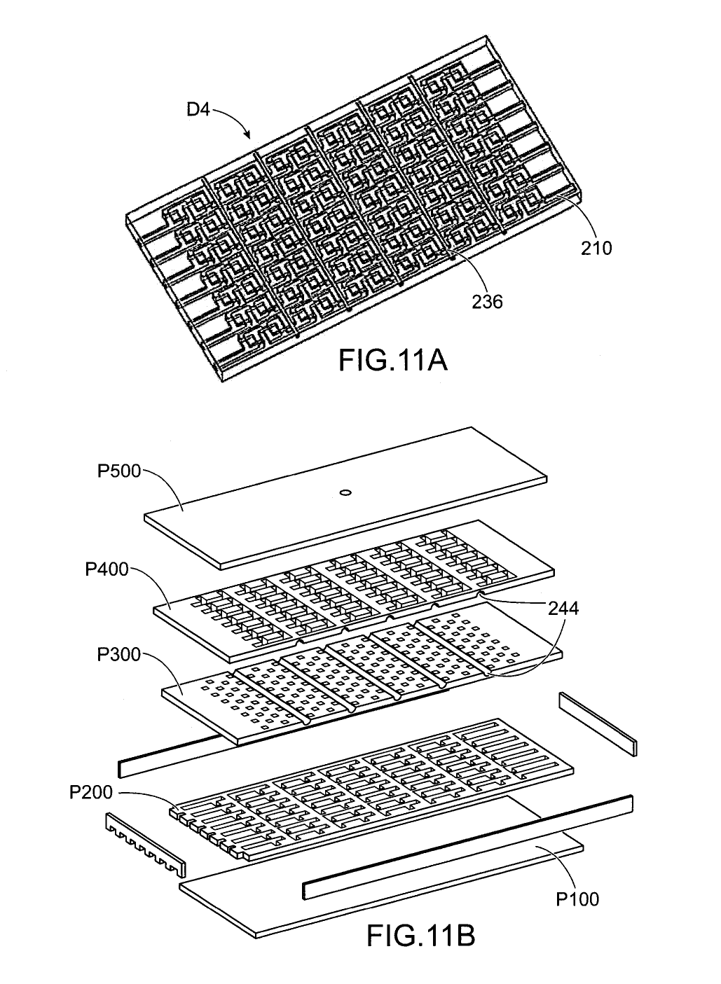

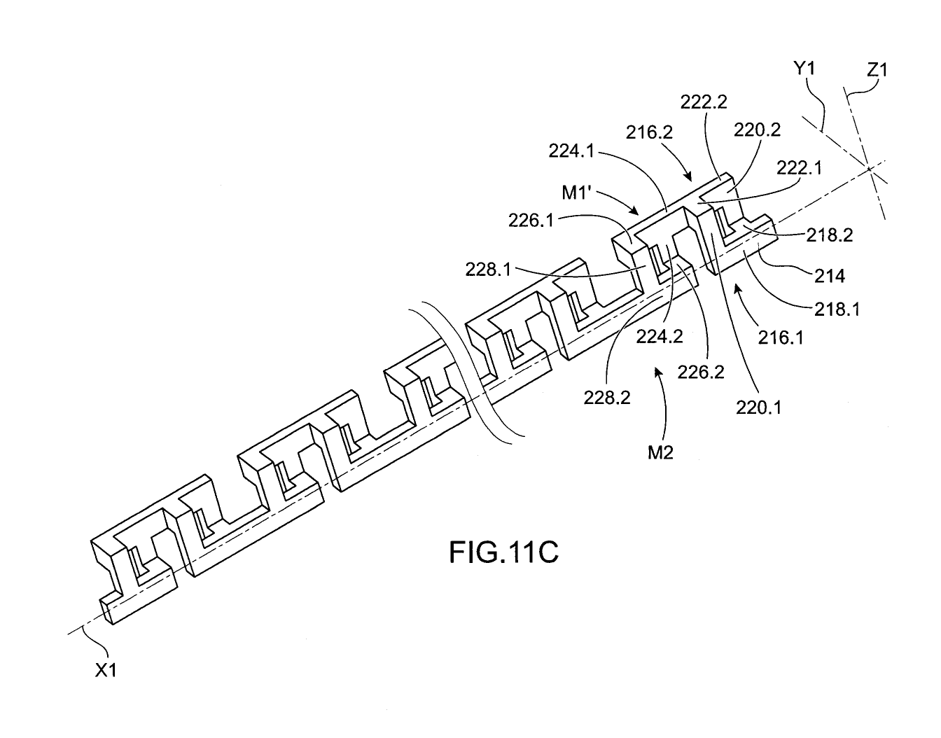

FIG. 11A is a perspective view in transparency of a fourth example embodiment of a blending device,

FIG. 11B is an exploded view of the device of FIG. 11A before its assembly by hot isostatic pressing,

FIG. 11C is a perspective view of a blending channel, according to another example embodiment,

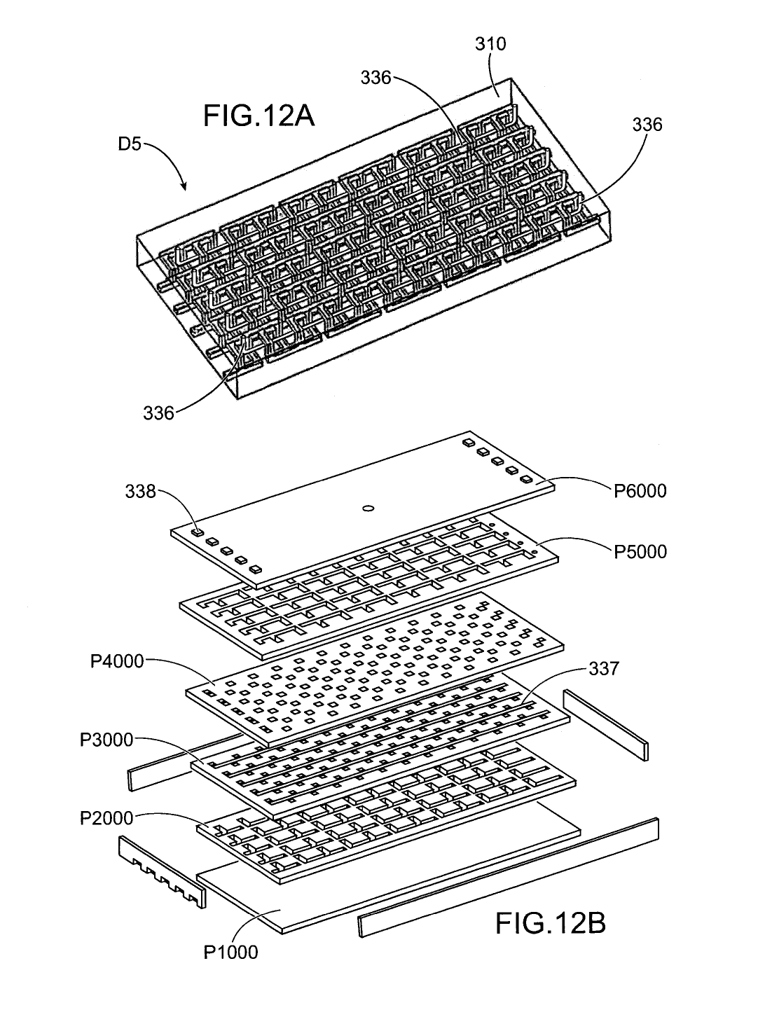

FIG. 12A is a perspective view in transparency of a fifth example embodiment of a blending device,

FIG. 12B is an exploded view of the device of FIG. 12A before its assembly by hot isostatic pressing,

FIG. 13 is a schematic front view of a chemical reactor having a heat exchange circuit of the state of the art.

### DETAILED ACCOUNT OF PARTICULAR EMBODIMENTS

In FIGS. 1 and 2 a first example of a device D1 intended to form a chemical reactor can be seen. In the remainder of the description the chemical reactor will be designated the device.

Device D1 comprises a body 2 of roughly parallelepipedic shape having an upper face 4.1 and a lower face 4.2 of greater area, and two longitudinal end faces 6.1, 6.2 and two lateral end faces 8.1, 8.2.

Device D1 comprises a first circuit C1 intended to form the chemical reactor, and will be designated below the “blending circuit”, and a second heat exchange circuit C2.

In the represented example, blending circuit C1 comprises several separate blending channels 10. A device in which the first circuit comprised only a single channel would not be outside the scope of the present invention. However, in the context of an industrial use it is advantageous to have several channels in which the chemical reactions take place, which enables the contact time of the chemical reagents to be increased with limited encumbrance.

Blending channels 10 extend between a first longitudinal face 6.1 and a second longitudinal end face 6.2 of the body, in which faces the channels emerge. Each blending channel defines a flow extending in a direction X1, X2, . . . Xn parallel to longitudinal axis X.

In the represented example, the blending channels are roughly identical, and only one of them will therefore be described in detail.

We shall consider a plane P comprising flow axes X1, X2, . . . Xn. Plane P is designated the average flow plane.

In FIGS. 2 and 3 blending channels 10 can be seen in detail.

Blending channel 10 comprises a succession of identical patterns M1, M2, . . . Mn connected fluidically in series. This series of patterns M1, M2, . . . Mn is particularly visible in FIG. 3.

In the represented example, pattern M1 and therefore, effectively, the blending channel formed from a succession of patterns, have axial symmetry relative to axis X1.

A reference point X1Y1Z1 is defined, where axes X1Y1Z1 are perpendicular to one another.

A pattern M1 comprises a first common pipe 14 of axis X1, in which all the fluid flows, followed by two second pipes 16.1, 16.2 dividing the fluid flow rate into two, designated the separation pipes.

Each second separation pipe 16.1, 16.2 comprises five portions of pipe, forcing the fluid to change direction more than once.

In the represented example, second separation pipe 16.1 comprises a first portion 18.1 of axis parallel to Z1 perpendicular to plane P and extending towards lower face 4.2, a second portion 20.1 of axis parallel to Y1 perpendicular to axis X1 and to axis Z1, extending towards lateral face 8.1, a third portion 22.1 of axis parallel to axis Z1, extending towards upper face 4.1, a fourth portion 24.1 of axis parallel to axis X1, contained in plane P and extending towards end face 6.2, and a fifth portion 26.1 of axis parallel to axis Y1 and extending towards lateral face 8.2.

Also in the represented example, second separation pipe 16.2 comprises a first portion 18.2 of axis Z1 perpendicular to plane P and extending towards upper face 4.1, a second portion 20.2 of axis parallel to Y1 extending towards lateral face 8.2, a third portion 22.2 of axis parallel to axis Z1 extending towards lower face 4.2, a fourth portion 24.2 of axis parallel to axis X1, contained in plane P and extending towards end face 6.2 of Z1 and a fifth portion 26.2 of axis parallel to axis Y1 and extending towards lateral face 8.1.

Fifth portions 26.1, 26.2 are connected to one another at axis X1 and are then connected to a first portion 14 of the next pattern.

Seen along axis X1, the blending channels are received between two end planes located either side of the average flow plane and parallel to it. In the represented example the end planes contain the outer walls of second portions 20.1, 20.2.

In each pattern the fluid is divided into two flows, which are subsequently brought together again.

Both second separation pipes are such that they cause roughly identical load losses. In the represented example they have a symmetrical structure.

In the represented example each separation pipe forces six changes of direction on the fluid. The separation pipes force at least three changes of direction on the fluid, as is the case in the structure represented in FIG. 11C, which will be described below.

In the represented example the blending channels are connected in series, such that the fluid makes out and return movements in the device. The first circuit is then shaped like a coil connected to an external supply and collection system by a first end 28 and a second end 30, both of which can be seen in FIG. 1. The first 28 and second 30 ends of first circuit C1 correspondent to the channels closest to the lateral faces of the body.

The intermediate channels are therefore connected via their longitudinal ends by transverse connection channels 32 located in longitudinal faces 6.1, 6.2 between the ends of two successive channels. These grooves are sealed by small plates 34. When it flows in these grooves 32, the fluid moves from one channel to an adjacent channel, changes direction and flows in the opposite direction. In the represented example the channels are formed by a trench connecting two adjacent channels and a small plate 34 sealing the trench, making it leak-proof. Advantageously, there is a groove on the outline of the trench, to position the small plate, which is attached, for example, by welding.

The transverse connecting channels 32 formed between the trench and small plate 34 have a cross section which is roughly identical to that of the longitudinal blending channels which they connect.

In small closure plates 34 it is advantageously possible to install one or more measuring instruments in order, for example, to collect data concerning the temperature, pressure and/or pH. By means of these small closure plates 34 it is also possible to introduce additional reagents, and/or to clean the channels in the event of soiling or solidification. Lastly, it is also possible, also by means of these small closure plates 34, to add static blenders or any other required insert, particularly inserts covered with catalysts.

Heat exchange circuit C2 comprises transverse channels 36 with axes parallel to axis Y, emerging in the lateral faces of the body.

Heat exchange channels 36 are located within the structure of the blending channels. Heat exchange channels 36 are located between average flow plane P and an end plane delimiting the upper or lower end of the blending channels.

In the represented example, heat exchange circuit C2 comprises channels 36 distributed in two planes parallel to plane P, either side of the latter. In addition, pairs of channels 36 are positioned between two successive patterns of blending channel 10.

In the represented example, pairs of channels 36 are located in the same plane perpendicular to plane P.

This distribution of the heat exchange channels is advantageous since it allows a large density of channels located as close as possible to the blending circuit, and therefore allows heat to be added or extracted optimally.

There may be fewer or more heat exchange channels 36. For example, it is possible to envisage having only a single channel 36 between two patterns by alternating the channels located above and below plane P.

In the represented example, and advantageously, heat exchange channels 36 are connected in parallel and connectors 38 for supply and collection of the heat exchange fluid, which can be seen in FIG. 1, are attached to the lateral faces of the body. This parallel connection allows very satisfactory homogenisation of the temperature to be achieved throughout the device.

However, as with the blending channels, they could be connected in series, and there could be only a single inlet and a single outlet of the heat exchange fluid.

In FIG. 1 connectors 40, to connect blending circuit C1 to a supply and collection system, can also be seen.

The number of blending channels 10 is chosen in accordance with time during which it is desired that the fluid should remain in the device. The number of heat exchange channels 36, for its part, is chosen according to the quantity of heat which it is desired to add or extract.

In the represented example, the channels of circuits C1 and C2 have a square section, which simplifies manufacture. However, circuits C1 and C2, which are formed of channels with a rectangular, elliptical or circular section, are not outside the scope of the present invention. Channels with a square or rectangular section could also be manufactured, and the sharp edges could be eliminated by then flowing an abrasive paste or indeed an acid, such as hydrofluoric acid, through the channels.

In FIG. 5A an exploded view of an example of the manufacture device D1 can be seen.

Device D1 is generally manufactured from a stack of plates which are previously structured such that they comprise portions of blending and heat exchange circuits.

More specifically, in the example represented the assembly constituting device D1 comprises a lower end plate P1 with no cut-outs, five intermediate structured plates P2 to P6 delimiting circuits C1 and C2, and an upper end plate with no cut-outs P7, having an aperture.

In this example embodiment, heat exchange channels 36 are formed from tubes 42 inserted between plates P2 and P3 and between plates P5 and P6, where said tubes 42 are received in transverse grooves 44 made in plates P2, P3 and P5, P6. Grooves 44 face one another, two-by-two, delimiting by this manner transverse recesses for tubes 42. The use of tubes 42 to cause the heat exchange fluid to flow enables a pressure-resistant device to be obtained. Indeed, the heat exchange fluid pressure may be of the order of 10 bars; this pressure is applied on to the walls of the tubes, and not directly on to plates P5 and P6 and P2 and P3.

As can be seen, plates P2 and P6 have identical slots, as do plates P3 and P5. However, the positioning of these slots is not necessarily the same. Indeed, since the blending channels of the structure have an axial symmetry relative to axis X1, the slots in plates P5, P6 are shifted along axis Y.

Central plate P4 is more particularly visible in FIG. 5B; this plate is the one which comprises average flow plane P, and which has slots 46 defining first pipe 14, and fourth and fifth portions 24.1, 24.2, 26.1, 26.2.

Advantageously, the slots in the plates are made by means of a laser device. The grooves receiving the tubes can also be manufactured by milling.

In addition, the assembly comprises side plates 48 with piercings 50 intended to receive the ends of tubes 42, and longitudinal end plates 52 intended to be pierced to allow connection to the first circuit.

Advantageously, central plate P4 comprises, at one longitudinal end, axial protrusions 54 aligned with axes X1, X2, . . . Xn, and longitudinal end plate 52 comprises slots 56 for the passage of axial protrusions 54. Protrusions 54 enable the positioning of the ends of blending channels 10 to be located, in order to pierce the longitudinal plates to create the transverse connection channels.

The production method comprises the following steps:
production of the device in the form of elements to be assembled, as described above, and
assembly by diffusion welding.

The method of assembly by diffusion welding consists in applying a high temperature and a high pressure to an assembly of parts, causing a diffusion of atoms between the parts.

Assembly by diffusion welding is preferentially an assembly by hot isostatic pressing of the elements of the device, designated below HIP.

The principle of HIP is to apply a high gas pressure to an assembly of metal, ceramic or cermet parts, where the gas is, for example, argon, at a high temperature over a given time. The effect of the pressure and temperature is to eliminate the gaps between the parts and to cause welding by diffusion of atoms at the solid state of these parts, called diffusion welding. A monolithic component is then obtained.

In order to apply the gas pressure to the external faces of the assembly, the external plates of the assembly form a container closed in leak-proof fashion, to which the gas pressure is applied, which transmits it to the internal elements.

In FIG. 6A closed container 58 can be seen.

With reference to FIG. 5A, container 58 is formed from lower plate P1, upper plate P7, side plates 48 and end plates 52.

Upper plate P7 comprises an aperture 60 to allow degassing of its internal volume, and more specifically the extraction of the gas trapped in the interfaces between the different parts of the assembly, and which could hinder the diffusion welding of the different parts of the assembly. For example a seal weld hole (not represented) is attached in aperture 60 to accomplish the degassing. The seal weld hole is then sealed before the HIP step.

Advantageously, upper and lower plates are chosen for the container which have sufficient thickness to prevent the container collapsing in the channels during the first HIP cycle.

In FIG. 6B an advantageous container detail of FIG. 6A can be seen. Side plates 48 and longitudinal end plates 52 of the container are dimensioned such that their ends overlap quarter by quarter, which enables the quality of the welding to be improved, and therefore satisfactory sealing to be accomplished. The welding between the different elements of the container is, for example, TIG welding.

Advantageously, the HIP is accomplished in two cycles:
a first cycle called the “low-pressure” cycle, for example at a pressure of between 50 and 150 bars, and at a temperature of between 1000° C. and 1100° C. for 2 h,
a second cycle after the channels are opened by piercing, called the “high-pressure” cycle, for example at a pressure of between 1000 and 1500 bars, and at a temperature of between 1000° C. and 1100° C. for 2 h. The channels are opened by making piercings in protrusions 54. Subsequently; to apply the pressure to the interior of the container the pressurised gas is introduced into the container through these piercings; the pressure is also applied via the gas to the external faces of the container. The effect of applying a pressure to the interior and exterior of the container is to press the various elements against one another, and to cause diffusion of the atoms between the parts.

The method of manufacture of the device of FIG. 5A comprises the following steps:
production of parts which, once assembled, will form the device; said parts are, for example, cut using a laser device,
insertion of the tubes between the plates in the grooves,
welding of the elements of the container to one another and of the tubes in piercings 50 of side plates 48 of the container so as to define a sealed system,
degassing of the interior of the container and sealing of the seal weld hole,
connection by HIP of the parts and the tubes,
machining to allow the connections of the blending and heat exchange circuit.

At the end of the HIP step container 58 can either be removed by machining or be retained, in its entirety or partially. In this latter case, the walls of the container are pierced or machined to reveal the heat exchange channels and the blending channels.

Following the HIP step, machining is accomplished which takes place in two stages.

Initially this is a “decladding” operation, by surfacing, in order to give a device the desired final dimensions, to unblock the blending channels at their inlets and outlets, and to check, if required, flatness and alignment of the upper and lower surfaces.

In a second stage the trenches intended to connect the adjacent blending channels are produced.

These trenches are then sealed in leak-proof fashion by small plates, as already described, where the latter are attached by welding. The cross section of these transverse connecting channels is roughly equal to the section of the blending channels. As previously described, a groove is advantageously produced around the opening of the recesses for installation and centring of the small plates.

In FIG. 7 an exploded view of another example embodiment of an assembly intended for the production of device D1 of FIG. 1 can be seen. This assembly differs from that of FIG. 5A in that the heat exchange channels are formed directly by the walls of grooves 44 made in the faces of plates P2, P3 and P5, P6. This assembly is simpler to produce, and of lower cost price.

As a non-restrictive example, we shall describe a practical example of production of a blending device represented in FIG. 5A.

The device can have the following external dimensions: width 87 mm, length 188 mm and height 20.4 mm. It comprises four blending channels 10 and twenty-two heat exchange channels 36, distributed in two planes. All blending channels 10 have a square section, their sides measuring 3 mm.

316L stainless steel is used to produce the different parts of the assembly.

The stack comprises seven 3 mm thick plates. The slots in the plates defining the blending channels are made using a laser. The tubes forming the heat exchange channels are made from 316L stainless steel, and have an internal diameter of 2 mm and an external diameter of 4 mm. The tubes are 91 mm in length; they extend across the entire width of the plates, and penetrate into side plates 48.

The lateral connectors intended to supply the heat exchange channels, and to collect the heat exchange fluid, are half-tubes made from 316L stainless steel, having an internal diameter of 14 mm and an external diameter of 16 mm, and being 188 mm in length.

Upper plate P7 and lower plate P1 of the container are 3 mm thick, preventing the container collapsing in the channels during the first HIP cycle. Conversely, side plates 48 can be chosen to have a smaller thickness, for example 2 mm, which enables the total volume to be restricted.

Upper plate P7 comprises aperture 60, of diameter 6 mm.

After the trenches are machined to produce the transverse connecting channels, small 316L steel plates are welded to close the trenches. The latter are 1 mm thick, inserted in grooves 0.2 mm deep.

The manufacturing method, and in particular the step of diffusion welding by HIP, enables large, complex surfaces to be assembled, without filling metal, which thus prevents the problems associated with the presence of low melting point materials such as, for example, limitation of the device's operating temperature, low corrosion resistance and pollution of the chemical reagents by the brazed joints.

In addition, the junctions obtained by diffusion welding are particularly resistant. The presence of welds traversing the walls, which can be a source of leaks, is avoided.

Assembly by HIP enables possible porosities to be eliminated. A 100% dense material is obtained, i.e. one which has no porosity. The assembly obtained in this manner has very satisfactory mechanical properties. In addition it is very simple to implement. In addition, the product obtained on conclusion of the HIP method is of high quality.

Furthermore, this technique can be applied to possible large components. For example, HIP furnaces exist which are 1.5 m in diameter and 3 m high.

In FIG. 9 another example embodiment of a blending device D3 can be seen, in which the heat exchange channels extend in several planes. In the represented example, the heat exchange channels are also orientated transversely relative to the average flow of the fluid in the blending channels.

Device D3 comprises blending channels 110 which are identical to channels 10 described above in the previous examples. Each of channels 110 extends along a longitudinal axis X1, X2.

Channels 136 are identical; a single channel will be described in detail.

Channel 136 extends along an axis Y1 orthogonal to axis X1 and comprises portions in which all the heat exchange fluid flows, and portions in which the fluid is separated into two, and flows either side of blending channels 110.

In the represented example, channel 136 comprises a first common portion 138 intended to be connected to the external heat exchange circuit, a first portion 140 forming a junction and extending either side of the first blending channel, a second common portion 142, a second portion 144 forming a junction, and extending either side of the second blending channel, and a third common portion 146, intended to be connected to the external heat exchange circuit.

The common portions extend in average flow plane P of the blending channels.

In the represented example heat exchange channels 136 comprise as many junction portions as there are blending channels.

The junction portions are formed by two U-shaped pipes positioned facing one another, and connected to the common portions at the ends of the U-shaped branches.

Heat exchange channels 136 are produced in a similar manner to the blending channels, by making slots in the plates.

As in the previous examples, heat exchange channels 136 intersect the blending channels at the point of connection between two patterns.

This example embodiment has the advantage that it has heat exchange channels which are even closer to the blending channels, since the junction portions laterally surround the channels, which therefore enables thermal control of the reactions occurring in the blending circuit to be improved. In addition, since these channels are produced in the same way as the blending channels, the manufacturing method is simplified and there are fewer steps to implement.

The heat exchange channels may be designed to have fewer junction portions than blending channels, or they may even have only two common portions at the lateral ends, and two junction portions either side of the blending channels.

In FIG. 10 an exploded view of the assembly used to manufacture the device of FIG. 9 can be seen. This comprises two end plates P10 and P70 and five intermediate plates P20 to P60 with slots intended to define the channels.

As can be seen in central plate P40, the latter comprises slots intended to form at once the pipe portions of the blending channels in plane P and the common portions of channels 136, where the latter form transverse slots 138 in plate P40.

In this example, since the device comprises only two blending channels 110, central plate P40 comprises only two positioning protrusions.

Connection and the achievement of leak-proofing of this assembly are obtained by HIP in a manner similar to the devices described above; this step will not be described again.

In FIG. 11A another example of a blending device D4 can be seen, in which the blending channels have a different shape.

Device D4 comprises a body 202 of roughly parallelepipedic shape having an upper face 204.1 and a lower face 204.2 of greater area, and two longitudinal end faces 206.1, 206.2 and lateral end faces 208.1, 208.2.

A single blending channel 210 is represented in FIG. 11C. It comprises common flow pipes and pipes in which the fluid is separated.

A reference point X1Y1Z1 is defined.

Blending channel 210 comprises a succession of identical patterns connected fluidically in series.

A pattern M1′ comprises a first common pipe 214 of axis X1 and two second pipes 216.1, 216.2 dividing the flow into two.

One of the second pipes 216.1 comprises a first portion 218.1 of axis X1, followed by a second 220.1 portion of axis parallel to Z1 extending towards upper face 204.1 in the representation of FIG. 11C, a third portion 222.1 of parallel axis Y1 extending towards lateral face 208.2, followed by a fourth portion 224.1 of axis parallel to X1, a fifth portion 226.1 of axis parallel to Y1 extending towards lateral face 208.1 and a sixth portion 228.1 of axis parallel to Z1 and extending towards lower face 204.2.

The other second pipe 216.2 comprises a first portion 218.2 of axis parallel to Y1 extending towards lateral face 208.2, followed by a second portion 220.2 of axis parallel to Z1 extending towards upper face 204.1, a third portion 222.2 of axis parallel to X1 extending towards longitudinal end 206.2, followed by a fourth portion 224.2 of axis parallel to Z1 extending towards lower face 204.2, a fifth portion 226.2 of axis parallel to Y1 and extending towards lateral face 208.1 and a sixth portion 228.2 of axis X1.

Third portions 222.1, 222.2 connect with one another; the fluid is then brought together again and then separated. Sixth portions 228.1, 228.2 are also connected, and then connect to the first common pipe of the following pattern.

Both second pipes have roughly the same load losses.

The blending channels are, for example, connected in series so as to form only a single circuit.

The blending channels, according to this embodiment, are contained in a parallelepipede of square section; they are more compact.

The example of FIG. 11A is similar to that of FIG. 1, since heat exchange channels 236 are transverse. In this example, heat exchange channels 236 are distributed in a single plane, and intersect blending channels 210 between two successive patterns. The plane of heat exchange channels 236 forms a median plane for blending channels 210. Heat exchange channels 236 intersect blending channels 210 as close as possible, consequently accomplishing a very satisfactory heat exchange.

In FIG. 11B an exploded view of the assembly of the elements used to manufacture the device of FIG. 11A can be seen.

The assembly comprises five superimposed plates P100 to P500, two end plates P100, P500, and three intermediate plates P200, P300, P400.

The three intermediate plates P200, P300, P400 have slots which, after the plates are assembled, define the blending and heat exchange channel circuits, as can be seen in transparency in FIG. 11A.

Lowest intermediate plate P200 is the one delimiting the ends connecting to the external circuit. Plate P200 advantageously comprises positioning protrusions aligned with the axes of blending channels 210.

In particular, heat exchange channels 236 are made from transverse grooves 244 made in the faces of intermediate plates P300, P400.

As in the example of FIG. 1, tubes could be inserted between grooves 244.

The assembly also comprises side plates and longitudinal plates; the one positioned on the side of the positioning protrusions comprises recesses enabling the positioning protrusions to be inserted.

In FIG. 12B another example embodiment of a blending device D5 can be seen, in which blending channels 310 are similar to those of FIG. 11C. Conversely, heat exchange channels 336 extend longitudinally. Each heat exchange channel 336 is positioned in the centre of a blending channel 310.

As can be seen in FIG. 11C, the blending channel delimits a free central passage extending from a first longitudinal end to a second longitudinal end, in which a channel isolated, in leak-proof fashion, relative to the pipe portions of the blending channel can be housed.

This positioning of heat exchange channel 336 in the centre of blending channel 310 enables the heat exchanges between blending channel 310 and heat exchange channel 336 to be improved still further.

In the represented example, the connections of heat exchange channel 336 with the external circuit are in the form of orthogonal pick-offs 338s in the device's medium plane. A connection can be comprised in the longitudinal faces. Channels 336 are supplied with heat transfer fluid, for example in parallel, by positioning transverse connectors on the upper plate.

Advantageously, the heat transfer fluid can be made to flow in a direction opposite to that of the fluid in the annular channels, which improves the exchanges. In the represented example, where the blending channels are connected in series, the fluid to be blended makes out and return movements, whereas the heat exchange fluid flows only in one direction. Thus, flowing in the opposite direction takes place at every other blending channel-heat exchange channel assembly.

In FIG. 12B an exploded view of the assembly of the elements used to manufacture device D5 of FIG. 12A can be seen.

The assembly comprises six plates, two end plates P1000, P6000, and four intermediate plates P2000, P3000, P4000, P5000 with slots. In plate P3000, slots 337 can be seen extending roughly along the entire length of the plates, and forming heat exchange channels 336.

Upper plate P6000 advantageously comprises protrusions 338 aligned along an edge, of which there are six, equal to the number of heat exchange channels 336. These protrusions enable the positioning of the vertical pick-offs to be located, and the heat exchange channels 336 to be then connected to the outside circuit.

In the represented examples the blending channels have identical structures. It could be arranged otherwise; for example, it could be envisaged to produce a device comprising blending channels of the example of FIG. 1 and channels of FIG. 11C.

In the represented examples the blending channels are connected in series and they are therefore where a single type of chemical reaction between at least two chemicals occurs. It can be envisaged to produce mutually independent sealed channels, and therefore to have different chemical reactions in different channels.

The devices according to the present invention have the advantage that they can be extrapolated in terms of size. Indeed, the sections of the channels can be increased without impairing thermal efficiency. The size of the structures of a device thus need merely be modified to adapt to the volumes of fluid to be treated, without having to analyse the heat exchange phenomena within the device of which the dimensions have been modified. Whatever the sizes of the channels, the blending properties, thermal properties and hydraulic properties are maintained.

By means of the invention and due to the particular arrangement of the blending channels and the heat exchange channels, heat exchange efficiency is substantially improved.

1-18. (canceled)

19. A device for blending at least two fluids comprising:
a circuit for blending said fluids and a heat exchange circuit wherein a heat transfer fluid is intended to flow;
said blending circuit comprising multiple channel networks positioned side-by-side, the channels of each network being interconnected, defining an average flow direction between a first longitudinal end and a second longitudinal end, the average flow directions of the multiple networks of channels being parallel, each network comprising common flow portions which are roughly parallel to the average flow direction, separation portions dividing the flow into two, the separation portions being connected to a common upstream flow portion and a common downstream flow portion, and each separation portion forcing at least three changes of flow direction;
said heat exchange circuit comprising multiple separate channels positioned side-by-side, said channels being positioned within the blending circuit, and extending from a first transverse end to a second transverse end, such that the average transverse flow direction in the exchange circuit is roughly perpendicular to the average flow direction in the blending circuit, and each of said channels being positioned between two successive separation portions of the networks of channels of the blending circuit;
the average longitudinal flowing direction and the average transverse flow direction defining an average flow plane;
at least one change of flow direction occurring in a plane separate from the average flow plane;
said at least one network of interconnected channels of the blending circuit being delimited by a first and a second end plane, both parallel to the average flow plane; and
said heat exchange circuit being positioned between said first and second end planes.

20. A blending device according to claim 19, wherein the channels of the heat exchange circuit comprise common portions and separation portions connecting to upstream and downstream common portions, where the separation portions extend on either side of the common portions of the networks of the blending circuit.

21. A blending device according to claim 19, wherein the heat exchange circuit comprises two separate parallel channels located on either side of the average flow plane.

22. A blending device according to claim 19, comprising multiple superimposed metal plates, connected by diffusion welding, each of the plates being etched such that it comprises at least a portion of the blending circuit and/or of the heat exchange circuit.

23. A blending device according to claim 22, wherein the plates are connected by hot isostatic pressing.

24. A blending device according to claim 19, wherein the heat exchange circuit is formed by interposition of metal pipes between the plates.

25. A blending device according to claim 19, wherein the heat exchange circuit is formed by pairs of grooves produced in faces of opposite superimposed plates.

26. A blending device according to claim 19, comprising side walls and longitudinal end walls surrounding the stack of plates, the longitudinal end plates comprising piercings to connect the blending circuit to a system supplying the fluid for blending, and to connect the heat exchange circuit to a system which causes a heat exchange fluid to flow.

27. A blending device according to claim 19, comprising side walls and longitudinal end walls surrounding the stack of plates, the longitudinal end plates comprising piercings to connect the blending circuit to a system supplying the fluid for blending, and the side walls comprise piercings to connect the heat exchange circuit to a system which causes a heat exchange fluid to flow.

28. A blending device according to claim 19, wherein at least one of the plates of the stack comprises, in at least one longitudinal end face, one longitudinal protrusion for each network of the blending circuit, said protrusion being aligned with the average axis of said associated network, and wherein the longitudinal end plate covering this face comprises slots to receive each longitudinal protrusion.

29. A blending device according to claim 19, manufactured from stainless steel.

30. A blending device according to claim 29, wherein the heat exchange circuit is formed by interposition of metal pipes between the plates and wherein the metal pipes are made from stainless steel.

31. A device for blending at least two fluids comprising:
a circuit for blending said fluids and a heat exchange circuit;
said blending circuit comprising multiple channel networks positioned side-by-side, the channels of each network being interconnected, each network defining an average flow direction between a first longitudinal end and a second longitudinal end, said network comprising common flow portions which are roughly parallel to the average flow direction, separation portions dividing the flow into two, the separation portions being connected to a common upstream flow portion and a common downstream flow portion, each separation portion forcing at least three changes of flow direction, and the average flow directions of the multiple networks being parallel;
said heat exchange circuit comprising multiple separate channels, said channels being positioned within the blending circuit and extending from a first longitudinal end to a second longitudinal end, such that the average flow in the exchange circuit is roughly parallel to the average flow in the blending circuit, each of said channels being positioned inside a space delimited by the channels forming the separation portions of a network of channels;
the average longitudinal flow direction and a transverse flow direction defining an average flow plane;
at least one change of flow direction occurring in a plane separate from the average flow plane;
said at least one network of interconnected channels of the blending circuit being delimited by a first pair of end planes which are parallel to one another, and parallel to the average flow plane, and a second pair of end planes which are parallel to one another, and the straight line intersecting with at least one of the planes of the first and at least one plane of the second pair of planes being parallel to the average flow direction; and
said at least one channel of the heat exchange circuit being positioned between said first and second pairs of end planes.

32. A blending device according to claim 31, wherein the direction of flow of a heat transfer fluid in the heat exchange circuit is opposite the direction of flow in the blending circuit over at least a part of the heat exchange circuit.

33. A blending device according to claim 31, wherein the networks of the blending circuit are connected such that the fluids to be blended flow at least in a first flow direction and in a second flow direction.

34. A blending device according to claim 31, wherein said blending device comprises multiple superimposed metal plates, connected by diffusion welding, each of the plates being etched such that it comprises at least a portion of the blending circuit and/or of the heat exchange circuit.

35. A blending device according to claim 34, wherein the plates are connected by hot isostatic pressing.

36. A blending device according to claim 31, comprising side walls and longitudinal end walls surrounding the stack of plates, the longitudinal end plates comprising piercings to connect the blending circuit to a system supplying the fluid for blending, and to connect the heat exchange circuit to a system which causes a heat exchange fluid to flow.

37. A blending device according to claim 31, wherein at least one of the plates of the stack comprises, in at least one longitudinal end face, one longitudinal protrusion for each network of the blending circuit, said protrusion being aligned with the average axis of said associated network, and wherein the longitudinal end plate covering this face comprises slots to receive each longitudinal protrusion.

38. A blending device according to claim 31, manufactured from stainless steel.

39. A blending device according to claim 38, wherein the heat exchange circuit is formed by interposition of metal pipes between the plates and wherein the metal pipes are made from stainless steel.

40. A method for production of a blending device according to claim 19, comprising:
a) cutting of multiple metal plates of roughly parallelepipedic shape;
b) cutting of patterns in at least a part of the plates;
c) stacking of the plates such that the patterns define the blending and heat exchange circuits;
d) connection of said plates by diffusion welding; and
e) cutting of the longitudinal faces to reveal the ends of the networks of the blending circuit, and to enable them to be connected to a supply system.

41. A method according to claim 40 wherein, in c), metal pipes are interposed between the plates to form the heat exchange circuit.

42. A method of production according to claim 40, wherein the stack of plates produced in c) comprises lower and upper metal plates containing no cut-outs, wherein said method further comprises c′) installation of side plates and of longitudinal end plates, so as to form a sealed container with the upper and lower plates with no cut-outs, and c″) degassing of the interior of said container.

43. A method for production of a blending device according to claim 31, comprising:
a) cutting of multiple metal plates of roughly parallelepipedic shape;
b) cutting of patterns in at least a part of the plates;
c) stacking of the plates such that the patterns define the blending and heat exchange circuits;
d) connection of said plates by diffusion welding; and
e) cutting of the longitudinal faces to reveal the ends of the networks of the blending circuit, and to enable them to be connected to a supply system.

44. A method according to claim 43 wherein, in c), metal pipes are interposed between the plates to form the heat exchange circuit.

45. A method of production according to claim 43, wherein the stack of plates produced in c) comprises lower and upper metal plates containing no cut-outs, wherein said method further comprises c′) installation of side plates and of longitudinal end plates, so as to form a sealed container with the upper and lower plates with no cut-outs, and c″) of degassing the interior of said container.
